(19) United States
(12) Patent Application Publication
(10) Pub. No.: US 2010/0074589 A1
(43) Pub. Date: Mar. 25, 2010

(54) Program Content Recovery for Multimedia Devices and Digital Video Recorder Set-Top Boxes

(75) Inventors: Chris A. Dinallo, Boca Raton, FL (US); Andrew Farrimond, Otlley (GB); William Ryan, Bury (GB)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: Pace plc

(21) Appl. No.: 12/236,826

(22) Filed: Sep. 24, 2008

(51) Int. Cl. H04N 5/94

(52) U.S. Cl. 386/47; 386/E05.035

(57) ABSTRACT

A system and method for recovering content in a multimedia device. Information pertaining to recorded content can be stored in a data store. If the recorded content is lost or damaged, the information in the data store pertaining to the recorded content can be accessed, and at least one content source can be continually searched until program information matching the accessed information is found. Once the program information is found, a re-recording of the content can be scheduled at a determined time designated by the content source. The lost or damaged recorded content can be restored by saving the re-recorded content on the same or other multimedia device. The information in the data store can be updated to indicate recovery of the recorded content and to prevent duplicate re-recordings.

### TECHNICAL FIELD

This invention relates generally to the field of digital recording, and more particularly to recovering content in multimedia devices.

### BACKGROUND ART

Current multimedia devices that include digital video recorder (DVR) capability, such as television set-top boxes, lack the ability to backup and restore subscriber content during a failure of the set-top box or its storage device. Subscriber content can generally include broadcast TV programs and non-broadcast programs, such as, downloads from the Internet. Typically, subscriber content can be stored on a storage device of the set-top box. The storage device can be internal to the set-top box, or may be an external Hard Disk Drive (HDD), or solid state memory.

During a failure of the set-top box or its storage device, all recorded content on the storage device may be permanently lost. Currently, there is no backup system for the content as in traditional computer systems. In addition, stored content may also be encrypted for the particular set-top box on which it was recorded. Typically, the encryption scheme is uniquely matched to the particular set-top box, and usually keyed on serial number and MAC ID address. As a result, merely having an external backup storage device to migrate over to another set-top box can prove useless, because the content cannot be decrypted by any set-top box other than the set-top box it was stored on due to the unique encryption keys. In other words, the stored content may only be operable with the set-top box on which the content was recorded.

Prior art systems that attempt to address the problem include U.S. Patent Application Publication No. 2005/0160308.

However, even if the set-top box and storage device containing the content could be ported to operate on another set-top box, the cost and practicality of having a second HDD available to perform regular backups would require constant diligence, due to new content being broadcast and recorded 24 hours a day, 7 days a week.

Accordingly, there is a need for a more responsive system and method to effectively backup and restore subscriber content during failures of multimedia devices and corresponding storage devices.

### SUMMARY OF THE INVENTION

In one aspect, the present invention provides a system for recovering content in a multimedia device. The system can include a data store for storing information pertaining to recorded content. A processor can be included for accessing the information in the data store pertaining to lost, damaged, or intentionally deleted recorded content, and for continually searching at least one content source until program information matching the accessed information is found. A scheduler can be included for scheduling a re-recording of the lost, damaged, or deleted recorded content at a determined time designated by the content source. A restoring process can be included for restoring the lost or damaged recorded content by saving the re-recorded content on the same or other multimedia device.

One or more of the following features may also be included. An update processor for updating the information in the data store to indicate that the lost or damaged recorded content is recovered, and to prevent duplicate re-recordings. The update processor may update the information in the data store only when the re-recorded content is recovered and saved on the multimedia device. A privacy mechanism for limiting access to the information in the data store. The privacy mechanism can include a personal identification number (PIN). The stored information and program information can include any one or more of program name, program description, Content Identifier Number (CIN), and program meta data. The data store can be an external data store. The data store can be a hand-held device. The data store can be a network server. The lost or damaged recorded content can include intentionally deleted recorded content. The content source can include any one or more of TV Guide Television Data Service, Video On Demand source, Internet site, and broadband video portal. The content source can be a broadcast source. The content source can be a non-broadcast source. The processor can encrypt the re-recorded content with a particular encryption method associated with the replacement multimedia device.

In another aspect, the present invention provides a method of recovering content in a multimedia device. The method includes storing information pertaining to recorded content in a data store, and if at least some of the recorded content is subsequently lost, damaged, or intentionally deleted then accessing the information in the data store pertaining to the lost or damaged recorded content, and continually searching at least one content source until program information matching the accessed information is found. This matching can be done to determine a time and the content source for re-recording the lost or damaged recorded content. Once the program information is found, the method includes scheduling a re-recording of the lost or damaged recorded content at a determined time designated by the content source. The method also includes restoring the lost or damaged recorded content by saving the re-recorded content on the same or other multimedia device.

One or more of the following features may also be included. Providing a privacy mechanism for limiting access to the information in the data store. Providing the privacy mechanism can further include requiring a personal identification number (PIN) to gain access to the data store. Periodically storing information pertaining to recorded content. Updating the information in the data store to indicate that the lost or damaged recorded content is recovered. Updating the information in the data store to prevent duplicate re-recordings. Accessing information in the data store pertaining to intentionally deleted recorded content. Encrypting the re-recorded content with the particular encryption method associated with the replacement multimedia device.

In another aspect, the present invention provides a method of preserving settings in a multimedia device. The method can include storing at least one setting associated with a multimedia device in an external data store, and if the multimedia device subsequently fails requiring a replacement device, retrieving the stored settings from the external data store. The method further includes automatically implementing the stored settings into the replacement device.

One or more of the following features may also be included. The stored settings may include one or more of font size, color, format, channels, and closed caption on/off. The stored settings may include a listing of user habits. The stored settings may include a listing of future scheduled program recordings.

In another aspect, the present invention provides a method of recovering accidentally or intentionally deleted content from a multimedia device. The method includes storing information pertaining to content deleted from a multimedia device in an external data store, retrieving the information from the data store and searching at least one content source for program information matching the stored information. The matching can be done to determine a time and the content source for re-recording the deleted content. The searching may continue until the program information is found. If the program information is found, the method includes scheduling a re-recording of the deleted content at the determined time and content source, and recovering the deleted content by saving the re-recorded deleted content on the multimedia device. The method then includes updating the information in the data store to remove the information pertaining to the recovered content to prevent re-recording over the recovered content.

### BRIEF DESCRIPTION OF DRAWINGS

FIG. 1 illustrates a system in accordance with one embodiment of the present invention.

FIG. 2 is a flowchart illustrating functional aspects of one embodiment of the present invention.

FIG. 3 illustrates a recovery process for use in connection with the present invention.

### DESCRIPTION OF SPECIFIC EMBODIMENTS

Generally, the present invention provides a system and method of recovering pre-recorded content that is lost or damaged during failures of multimedia devices and associated storage devices, which store the pre-recorded content. The system and method of the present invention can also be utilized to recover accidentally or intentionally deleted pre-recorded content. In various embodiments, the system attempts to re-record lost, damaged, or deleted content onto a replacement multimedia device, such as, a set-top box and associated HDD. Content can include video or program recordings, user preference settings, and settings for future scheduled recordings. In an embodiment, a listing of intentionally deleted content can be maintained to preserve the ability to subsequently recover the deleted content.

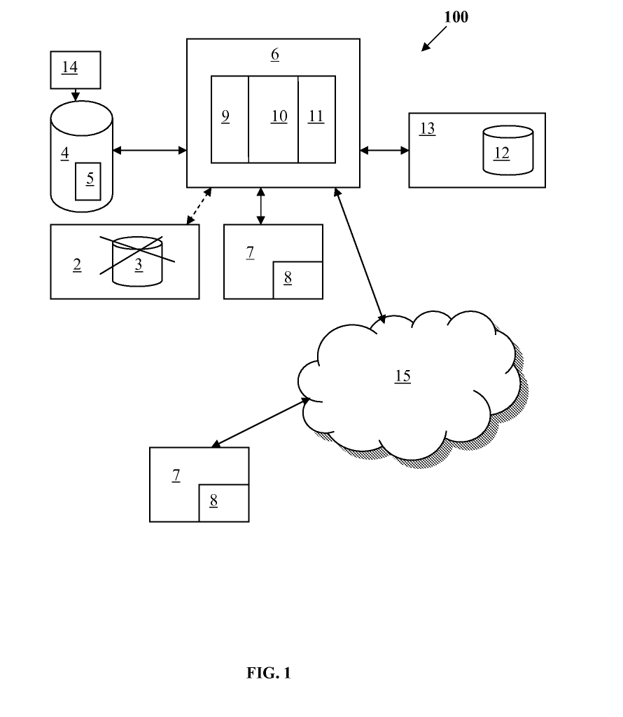

Referring now to FIG. 1, in an embodiment, the present invention provides a system architecture 100 for recovering prerecorded content 3 in a failed multimedia device 2, such as a set-top box. The system 100 can include a data store 4 for storing information 5 pertaining to recorded content 3. The data store 4 can be an external data store, such as, a network server or portable hard drive. The data store 4 can also be a hand-held device, such as, a Universal Serial Bus (USB) memory stick. The data store 4 can include a privacy mechanism 14 for limiting access to the information 5 in the data store 4. For example, a user attempting to access the data store 4 may be required to enter a personal identification number (PIN) in order to gain access to the data store 4.

A processor 6 can be included for accessing the information 5 in the data store 4 pertaining to prerecorded content 3, and for searching at least one content source 7 for program information 8 matching the accessed information 5 to determine a time and the content source 7 for re-recording the lost, damaged, or deleted recorded content 3. It should be appreciated that the content source 7 may be connected to the processor 6 directly, wirelessly, or through a network 15. In addition, the content source 7 can be a broadcast source or non-broadcast source. The content source 7 can also include any one or more of a TV Guide Television Data Service, Video On Demand source, Internet site, and broadband video portal.

In an embodiment, the stored information 5 and program information 8 can include a program name, program description, Content Identifier Number (CIN), and program meta data, or a combination thereof. The processor 6 may be implemented in software, hardware, or a combination of both. In accordance with an embodiment of the present invention, the processor 6 can continually search content sources 7 until program information 8 matching the stored information 5 is found. The processor 6 can further include a scheduler 9, a restoring process 10, and an update processor 1 1, all of which can provide specific functionality and can be components or features of the processor 6. Alternatively, each of these components may be standalone software or hardware modules that interact with the processor 6.

The scheduler 9, in one embodiment, can be included for scheduling a re-recording of the lost or damaged recorded content 3 at the determined time and content source 7. The restoring process 10, on the other hand, can be included for restoring the lost or damaged recorded content 3 by saving the re-recorded content 12 on the same or other multimedia device 13. In an embodiment, an update processor 11 can also be included for updating the information 5 in the data store 4 to indicate that the lost or damaged recorded content 3 has been recovered and to prevent duplicate re-recordings. By design, the update processor 11 of the present invention updates the information 5 in data store 4 only after the recorded content 3 has actually been recovered and saved on the multimedia device 13. In other words, once the re-recording of the content 3 (i.e. the program) has spanned substantially the designated time period by the content source 7 for that particular program, will the update processor 11 update the information in data store 4.

When multimedia device 2 (e.g., DVR set-top box), is functioning properly, the processor 6 can automatically and periodically interrogate recorded content 3 on device 2 to identify information pertaining to each program recorded on the device 2. The information may not include actual program content, but may include program name, program description, episode ID, CIN, and meta data for each stored program. It should be noted that this information pertaining to each recorded program may typically be only about 1 Kb of data per program. As a result, the processor 6 can periodically collect and store this information 5 in data store 4 as, for instance, a content list. Since the information 5 is typically a small amount of data, inexpensive, portable, fast, memory storage mediums can be used to implement the data store 4. For example, the data store 4 can be an external storage medium, such as, a Universal Serial Bus (USB) memory stick. Alternatively, the data store 4 can also be a network server or external hard drive. From information 5, the processor 6, in an embodiment, can initiate functionality to recover and restore the lost recorded content 3 as re-recorded content 12 onto another multimedia device 13.

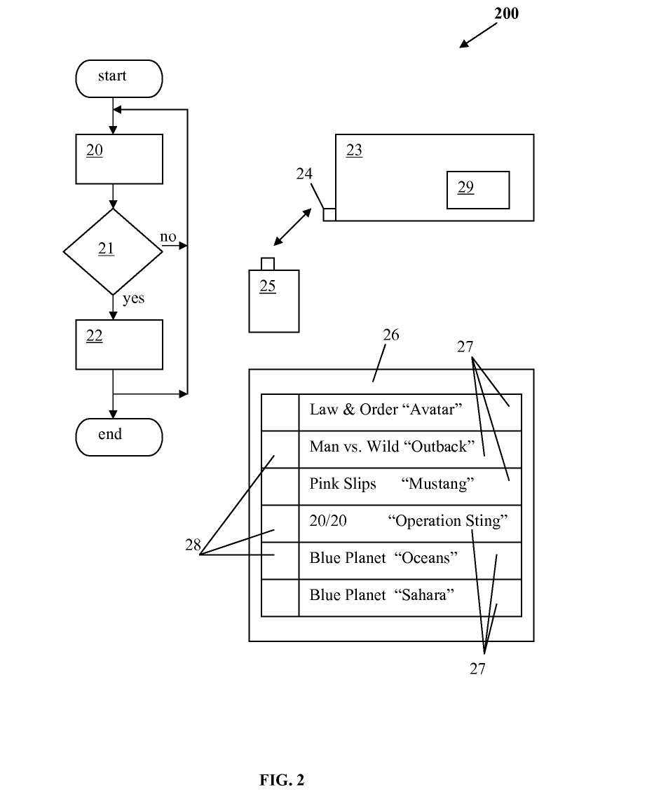

Referring to FIG. 2, flowchart 200 illustrates an exemplary process of gathering information and storing it in a data store 4, such as, content list 26. Initially, a time schedule (20) can be utilized to determine periodic intervals at which recorded content stored on a hard drive 29 in a multimedia device 23 can be monitored and stored. At a predetermined time interval (20), processor 6 (operating on device 23) can determine (21) if USB memory stick 25 is attached to the multimedia device 23 through port 24. If the USB memory stick 25 is not attached, then the processor 6 can reattempt at the next time interval. If USB stick 25 is attached, then the processor 6 can retrieve the relevant information as content list 26 from hard drive 29, and can store (22) the content list 26 onto USB stick 25. This process then repeats at the next time interval (20), thereby updating the information stored on the USB stick 25. The entire process, in one embodiment, occurs transparently to a user, and with no performance impacts on the multimedia device 23.

In an embodiment, the content list 26 stored on the USB stick 25 can include several records 27. Each record 27 can pertain to a single program, and may include multiple entries. For example, a particular record 27 may include the program name and episode name, i.e., “Law & Order-Avatar” of a particular program recorded on device 23. The content list 26 can also include a status field 28, which the processor 6 can update to indicate that pre-recorded content pertaining to a particular record 27 has been scheduled for re-recording, recovered, or deleted.

Multimedia devices 2, 23 can fail in various ways resulting in a loss of recorded content. Typically, the set-top box will fail or the HDD 3, 29 within the set-top box will fail. In the event the multimedia device 2, 23 fails, the USB device 4, 25 can be removed from the failed device 2, 23 and inserted into a replacement multimedia device 13. This can initiate the processor 6 to read and access the information 5 (content list 26) stored in data store 4 or on the USB memory stick 25. The processor 6 can then continuously search at least one content source 7 (e.g. TVGuide Television Data Service, Video On Demand source, Internet site, and other broadband type video portals) for program information 8 matching the accessed information 5. This matching can be done to determine a time and the content source for re-recording the lost or damaged recorded content. The search continues until the program information is found. The overall process executes transparently in the background, and does not complete until all previously recorded programs have been successfully re-recorded (i.e. restored).

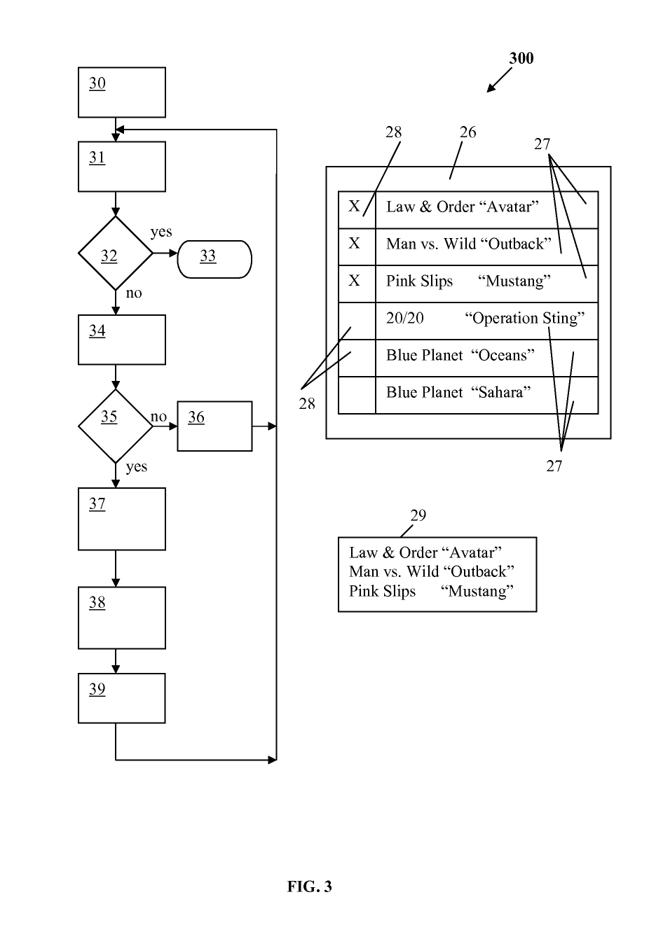

Referring to FIG. 3, flowchart 300 illustrates an exemplary recovery process. Initially, the USB device 25 can be inserted (30) into the multimedia device 23 to initiate the processor 6 into action. The processor 6 attempts to read the first record 27 from the content list 26. If the content list 26 is empty (32), the processor 6 halts (33). If the content list 26 is not empty, the processor 6 reads the first record 27 of the content list 26, and searches (34) one or more content sources 7 to find matching program information. If a match is not found (36), then the processor 6 leaves that particular record 27 in the content list 26, so that it will be continuously searched for during subsequent iterations until found. If a match is found (35), then the processor 6 can direct the device 23 to schedule (37) a re-recording of the lost or damaged recorded content at a time designated by content source 7 where the program is being re-broadcasted (or available via other sources such as the Internet).

The lost content can then be re-recorded and restored (38) by saving the re-recorded content onto multimedia device 23 in associated HDD 29. The processor 6 can then mark (39) the corresponding status field 28 in content list 26 to indicate the restored status of the lost content. The recovery process can then repeat with the processor 6 reading the next record 27 from the content list 26. The processor 6 works its way through each entry in the content list 26, one at a time, until all the entries have been restored. In doing so, the processor 6 examines the status field 28 for each entry to determine, for instance, if the entry has already been recovered, if scheduling is required, or if the entry should be deleted from the content list 26. To that end, updating the status field 28 can prevent duplicate re-recordings.

The status field 28 can also be utilized to resynchronize the recovery process after a power failure, or other unforeseen event that interrupts the recovery process. For example, following a power failure that interrupts the recovery process, the recovery process can be restarted and the processor 6 can evaluate the status fields 28 in the content list 26 to determine a starting point that coincides with where the processor 6 left off due to the interruption. Alternatively, the recovery process can be re-initiated from the beginning as described above.

In an embodiment, the processor 6 can also encrypt the re-recorded content with a particular encryption method associated with the replacement multimedia device 23. This protects and preserves the necessary encryption scheme so that the rerecorded content does not fall to piracy.

In another embodiment, the present invention provides a method of preserving settings in a multimedia device. The method can include storing at least one setting associated with a multimedia device 2 in an external data store 4, 25. The stored settings may include font size, color, format, channels, and closed caption on/off. The stored settings may also include a listing of user habits, or a listing of future scheduled program recordings. If the multimedia device 2 subsequently fails requiring a replacement device 13, the stored settings can be retrieved from the external data store 4, 25. Thereafter, the stored settings can be automatically implemented by the processor 6 into the replacement device 13.

In another embodiment, the present invention provides a method of recovering deleted content from multimedia device 2. The method includes storing information 5 pertaining to content deleted from a multimedia device 2 in an external data store 4, 25, subsequently retrieving the information 5 from the data store 4, 25, and searching at least one content source 7 for program information 8 matching the stored information 5. The information 5 and programming information 8 can include program name, program description, CIN, and meta data. Retrieving the information 5 from the data store 4, 25 can include accessing the data store with a personal identification number. The matching can be done to determine a time and the content source 7 for re-recording the deleted content 3. The searching may continue until the program information 8 is found. If the program information 8 is found, the method includes scheduling a re-recording of the deleted content 3 at the determined time designated by the content source, and recovering the deleted content 3 by saving the re-recorded deleted content 12 on the multimedia device 13. The method then includes updating the information in the data store 4, 25 to remove the information pertaining to the recovered content to prevent re-recording over the recovered content.

The present invention provides many advantages and benefits to Pay TV Operators (e.g., Cable/Satellite/IPTV Providers) and end-users alike. Advantages include 1) ease of use and automatic functionality, 2) portable to a variety of multimedia devices, 3) transparent operation, 4) inexpensive, 5) functions with existing TVGuide Electronic Program Guide and Guide Data Sources, 6) small memory footprint, and 7) does not infringe intellectual property rights of third-party content providers.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

We claim:

1. A system for recovering content in a multimedia device comprising:
a data store for storing information pertaining to recorded content;
a processor for accessing the information in the data store pertaining to lost or damaged recorded content, and designed to continually search at least one content source until program information matching the accessed information is found;
a scheduler for scheduling a re-recording of the lost or damaged recorded content at a determined time designated by the content source; and
a restoring process for restoring the lost or damaged recorded content by saving the re-recorded content on the same or other multimedia device.

2. The system of claim 1, further comprising an update processor for updating the information in the data store to indicate that the lost or damaged recorded content is recovered.

3. The system of claim 2, wherein the update processor updates the information in the data store to prevent duplicate re-recordings.

4. The system of claim 2, wherein the update processor updates the information in the data store when the re-recorded content is recovered and saved on the multimedia device.

5. The system of claim 1, further comprising a privacy mechanism for limiting access to the information in the data store.

6. The system of claim 5, wherein the privacy mechanism includes a personal identification number (PIN).

7. The system of claim 1, wherein the stored information includes any one or more of program name, program description, Content Identifier Number (CIN), and program meta data.

8. The system of claim 1, wherein the program information includes any one or more of program name, program description, Content Identifier Number (CIN), and program meta data.

9. The system of claim 1, wherein the data store is an external data store.

10. The system of claim 1, wherein the data store is a hand-held device.

11. The system of claim 1, wherein the data store is a network server.

12. The system of claim 1, wherein the lost or damaged recorded content includes intentionally deleted recorded content.

13. The system of claim 1, wherein the content source includes any one or more of TV Guide Television Data Service, Video On Demand source, Internet site, and broadband video portal.

14. The system of claim 1, wherein the content source is a broadcast source.

15. The system of claim 1, wherein the content source is a non-broadcast source.

16. The system of claim 1, wherein the processor can encrypt the re-recorded content with a particular encryption method associated with the replacement multimedia device.

17. A method of recovering content in a multimedia device, the method comprising:
storing information pertaining to recorded content in a data store;
if at least some of the recorded content is subsequently lost or damaged, accessing the information in the data store pertaining to the lost or damaged recorded content;
continually searching at least one content source until program information matching the accessed information is found;
once the program information is found, scheduling a re-recording of the lost or damaged recorded content at a determined time designated by the content source; and
restoring the lost or damaged recorded content by saving the re-recorded content on the same or other multimedia device.

18. The method of claim 17, further comprising updating the information in the data store, once the restoring step is completed and the re-recorded content saved, to indicate that the lost or damaged recorded content is recovered.

19. The method of claim 18, wherein updating includes updating the information in the data store to prevent duplicate re-recordings.

20. The method of claim 17, further comprising providing a privacy mechanism for limiting access to the information in the data store.

21. The method of claim 20, wherein providing the privacy mechanism includes requiring a personal identification number (PIN) to gain access to the data store.

22. The method of claim 17, wherein storing includes periodically storing information pertaining to recorded content.

23. The method of claim 17, wherein accessing includes accessing information in the data store pertaining to intentionally deleted recorded content.

24. The method of claim 17, further comprising encrypting the re-recorded content with the particular encryption method associated with the replacement device.

25. A method of preserving settings in a multimedia device, the method comprising:
storing at least one setting associated with a multimedia device in an external data store;
if the multimedia device subsequently fails requiring a replacement device, retrieving the stored settings from the external data store; and
automatically implementing the stored settings into the replacement device.

26. The method of claim 25, wherein the stored settings include one or more of font size, color, format, channels, and closed caption on/off.

27. The method of claim 25, wherein the stored settings include a listing of user habits.

28. The method of claim 25, wherein the stored settings include a listing of future scheduled program recordings.
